(19) United States
(12) Patent Application Publication
(10) Pub. No.: US 2004/0238703 A1
(43) Pub. Date: Dec. 2, 2004

(54) Clamps

(76) Inventors: Yinka Davies, London (GB); Raymond Adewunmi, Buckinghamshire (GB)

Correspondence Address: DARBY & DARBY P.C., P. O. BOX 5257, NEW YORK, NY, 10150-5257, US

(21) Appl. No.: 10/798,810

(22) Filed: Mar. 10, 2004

(30) Foreign Application Priority Data
Mar. 12, 2003 (GB) 0305659.5
Mar. 24, 2003 (GB) 0306561.2

(51) Int. Cl. B25B 1/00

(52) U.S. Cl. 248/229.24

(57) ABSTRACT

The clamp device of the invention comprises at least one clamp mounted on a support means and capable of rotation thereon. The clamp is constituted by a pair of clamping arms hingedly connected at one end to allow pivoting of said arms between open and closed positions, and each arm is shaped and/or adapted at its other end to exert clamping pressure in the closed position of the clamp. An actuating mechanism is provided on the said support means which, on rotation thereof, is capable, in one direction of rotation, of opening the clamp by causing the clamping arms to move away from one another at said other end thereof, and, in the opposite direction of rotation, of closing the clamp by causing said other ends to approach one another and to exert clamping pressure. A preferred form of the device, which is an universal clamp device, comprises a pair of clamps mounted on a support means and capable of independent rotation thereon, each clamp being constituted by a pair of clamping arms hingedly connected at one end to allow pivoting of said arms between open and closed positions in the use of the clamp, and each clamping arm being shaped and/or adapted to exert clamping pressure at its other end in the closed position of the clamp. A locking mechanism is provided on said support means which; in its locking state, links said clamps together to prevent movement thereof as a whole independently of one another, and, in its unlocked state, allows each clamp to move independently of the other on the support means, separate actuating means being provided for the clamps to allow opening and closing of each clamp independently of the other. In another embodiment of the invention, the clamp device comprises one clamp only as defined above and is optionally provided, mounted on the support means, with a plurality of disc members which are pierced to provide means for attachment of the ribs of a raincover as described and claimed in GB patent no. 2,366,254.

A particular application of clamps is to the invention embodied in our GB patent 2366254 and our international application PCT/GB01/05595 relating to a child-vehicle pusher's raincover. The description of that patent an application, including the disclosure provided by the claims of the said patent and application, is intended to be incorporated into this present application by way of reference to the particular uses of clamps referred to therein. It will be understood, however, that improvements have been made in the clamps referred to in the said patent and application which have resulted in the present invention. It will also be understood that the improved clamps of the present invention are of wider application than the child vehicle pusher's raincovers of the said patent and application, and may be used in a wide variety of cases, particularly, where an universal clamp is needed to provide both clamping and relative freedom of movement as required by the mechanical applications for which universal clamps are particularly suited.

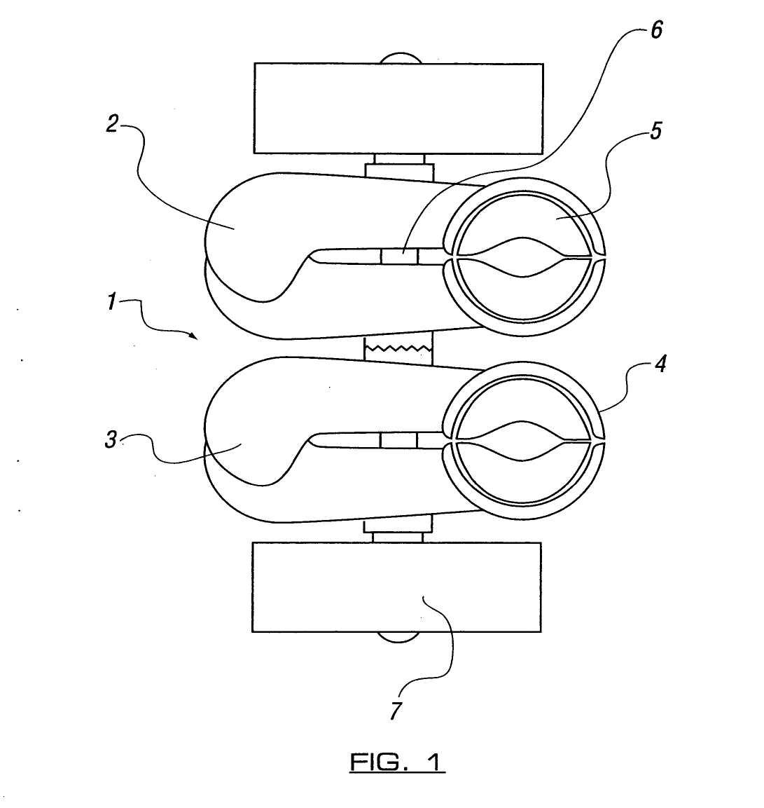

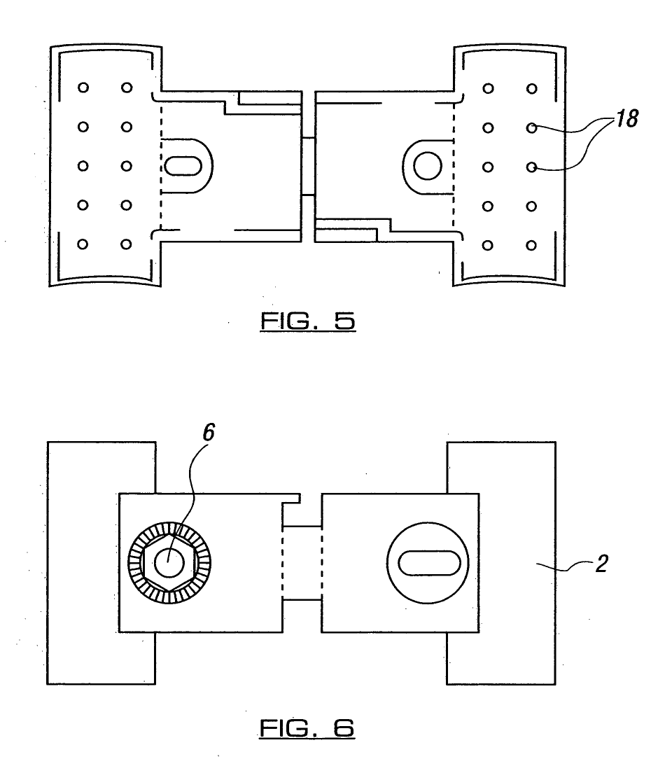

The raincover referred to above in connection with the said patent and application is best summarized in the above noted international application PCT/GB01/05595 as a child-vehicle pusher's raincover which is detachable, adjustable and retractable, and comprises two main parts, namely, a raincover (1, 2) which shelters the pusher from rain/snow, for example, and a pair of adjustable supporting telescopic pole members (4,5) which extend out of, and retract within themselves, to allow the user to adjust the height of the raincover to a desired height, each telescopic pole (4,5) being preferably provided with a tightening device which allows each telescopic pole (4,5) to be set at the desired length achieved by sliding movement of one part of the telescopic pole (4 or 5) within the other, a lower end of each telescopic pole (4,5) being attachable to the frame of a child carrying vehicle whilst a raincover is attachable to an upper end of a pole (4,5), the raincover being kept in a desired position for use (see FIG. 1 of the said GB patent or of the said PCT application) by a pair of dual functioning clamps (3) and the adjustable telescopic poles (4,5) supporting the raincover (1,2) being detachably attached to the vehicle by dual functioning universal clamps (6) which permit both complete detachment of the raincover from the vehicle and angle movement both backwards and forwards around the point of fixing. In a preferred embodiment,.elasticated clips (7), as shown in FIG. 7 of the said GB patent and of the said PCT application, provide additional support for storage purposes.

The present invention focuses on the dual functioning clamps of the above noted GB patent and PCT application and is the result of an improvement in the two kinds of dual functioning clamps originally provided for use with the raincover frame, specifically, the ordinary clamps (3) and the universal clamps (6).

The clamps which are the result of our effort of improvement have been found to have real advantages in use as described above with the child vehicle pusher's raincover and also in the many and varied uses to which dual functioning clamps, which are part of the present state of the art, are presently normally put.

Accordingly, the present invention consists in a clamp device comprising at least one clamp mounted on a support means and capable of rotation thereon, the clamp being constituted by a pair of clamping arms hingedly connected at one end to allow pivoting of said arms between open and closed positions, and each arm being shaped and/or adapted at its other end to exert clamping pressure in the closed position of the clamp, and an actuating mechanism being provided on said support means which, upon rotation thereof, is capable in one direction of rotation of opening the clamp by causing the clamping arms to move away from one another at said other ends thereof, and, in the opposite direction of rotation, of closing the clamp by causing said other ends to approach one another and to exert clamping pressure.

Although the invention covers both ordinary dual functioning clamp devices comprising one clamp only, according to a preferred aspect of the invention, an universal clamping device is provided which comprises a pair of clamps as defined just above independently mounted on the support means, the device being provided with means for locking the two clamps together so that they are incapable of rotating on the support means independently of one another, the locking means being actuatable to a position in which the clamps are released and able to rotate on said support means independently of one another.

Accordingly, the present invention also consists, according to a preferred aspect, in an universal clamp device comprising a pair of clamps mounted on a support means and capable of independent rotation thereon, each clamp being constituted by a pair of clamping arms hingedly connected at one end to allow pivoting of said arms between open and closed positions, and each arm being shaped and/or adapted at its other end to exert clamping pressure in the closed position of the clamp, a locking mechanism being provided on said support means which in its unlocked state allows the clamps to move independently of one another and in its locked state prevents independent movement of the clamps relative to one another, each clamp of the pair being also provided with a separate and independent actuating mechanism which upon rotation in one direction causes the associated clamp to be opened, and, on rotation in the opposite direction, causes the associated clamp to be closed.

In a preferred embodiment of the invention, an insert composed of a rubber or rubber like material, or other suitable elastomeric material, is provided at the clamping end of each arm to improve the grip of the arms when the clamps are in their closed positions.

In another preferred embodiment of the invention, a rod like externally threaded component is passed through the clamps and acts as a support means, the locking mechanism being supported on the said externally threaded component.

As indicated above, actuating mechanisms are provided which, upon rotation, act upon the clamps in such manner that rotation of the actuating mechanism in one direction causes the opening of a clamp by the movement of the gripping ends of the clamping arms away from one another, and rotation in the other direction acts on the clamp to bring said clamp to its closed state in which said gripping ends are brought together so as to exert a gripping action on an object held by the said clamp.

For a better understanding of the invention, reference is now made to the accompanying drawings in which:

FIG. 1 is an elevation of one embodiment of dual functioning universal clamp device according to the invention;

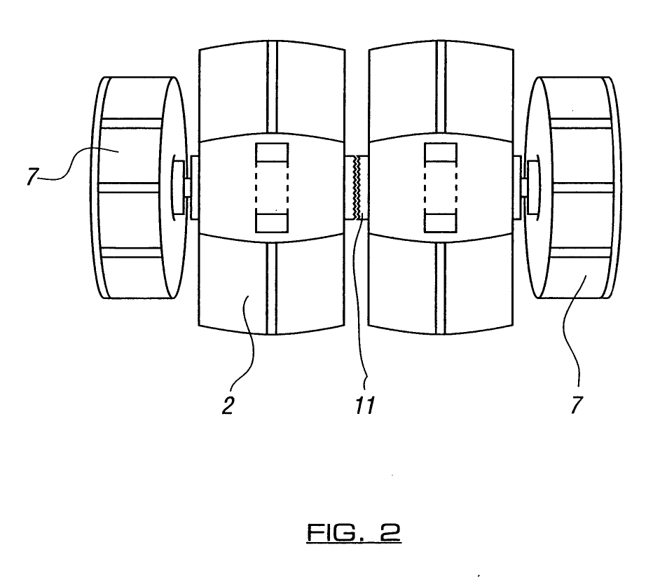

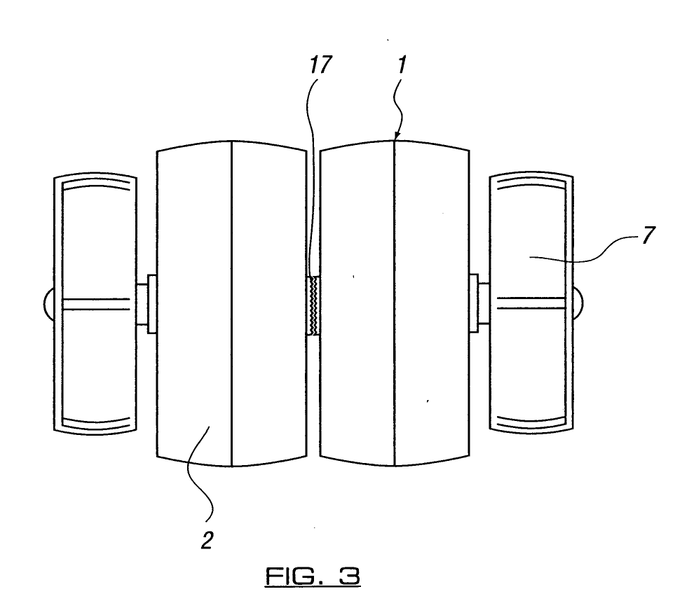

FIGS. 2 and 3 are corresponding side views from the left- and right-hand side, as seen in FIG. 1, respectively;

FIG. 4 is a corresponding plan view;

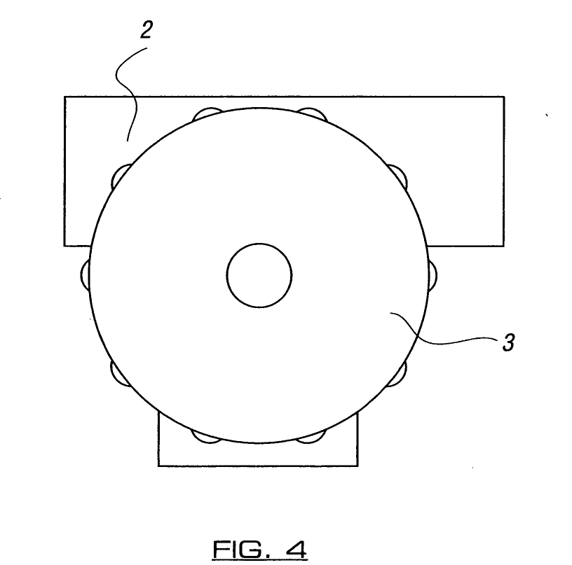

FIGS. 5 and 6 are further side views corresponding to FIGS. 1-4; and

FIG. 7 is an elevation of a dual functioning non-universal clamp device according to the invention;

FIG. 8 is a corresponding plan view;

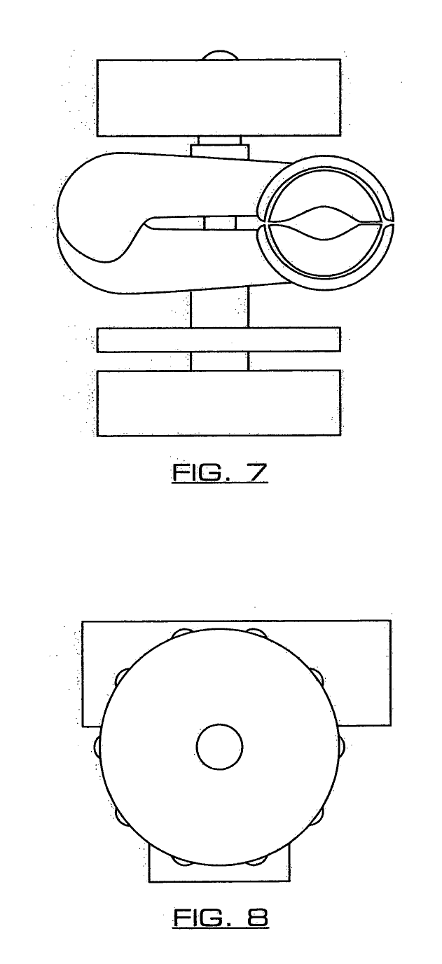

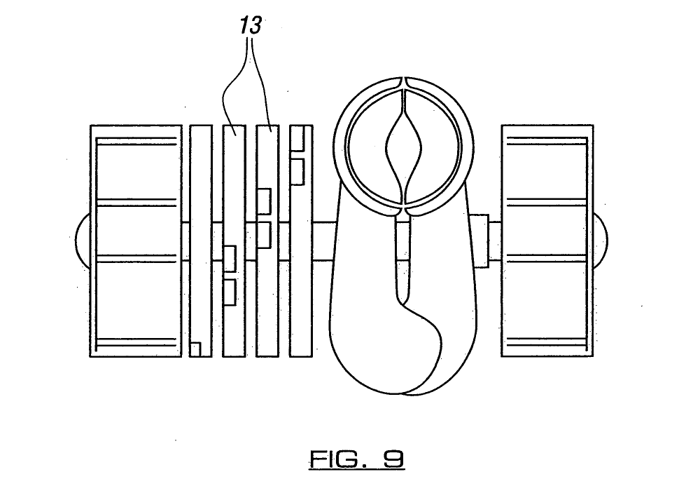

FIGS. 9 and 10 are further views of the non-universal dual functioning clamp device of the invention; and

FIGS. 11-16 are views of details of the clamp device of the invention.

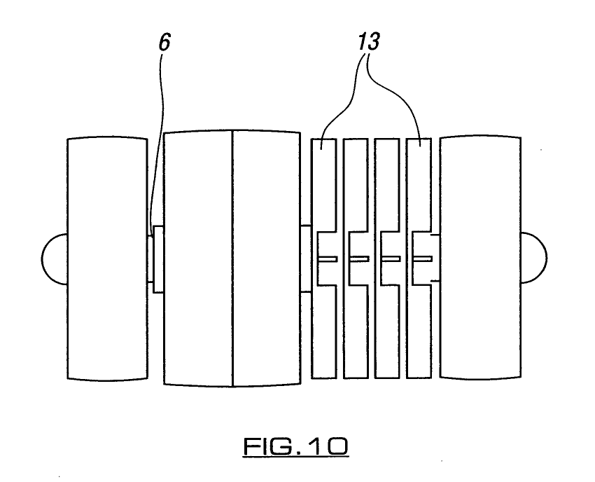

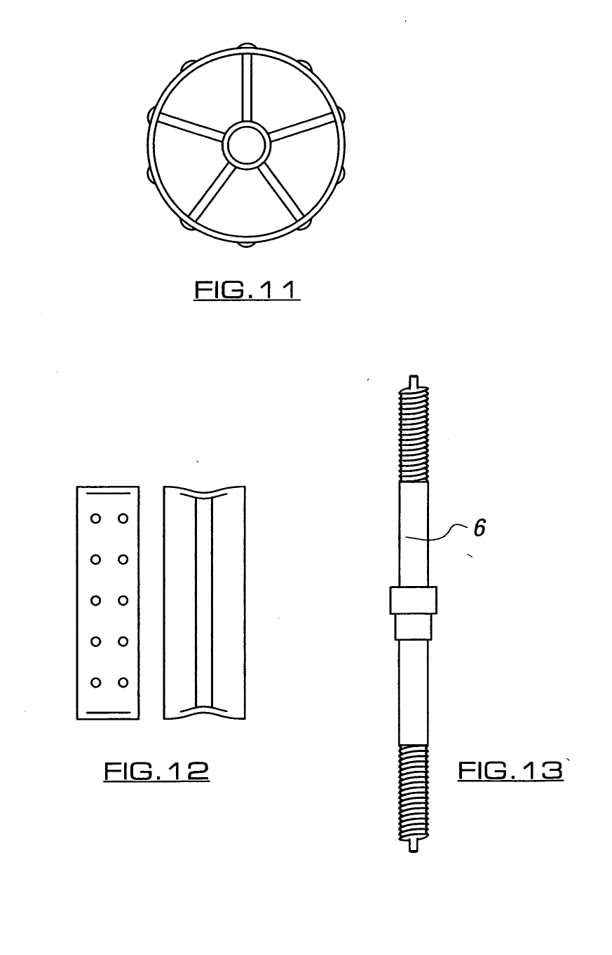

The universal dual functioning clamp device shown in FIGS. 1-6 comprises two clamps 1 adjacent to each other and capable of working together, as will be described below. Each clamp 1 is constituted by a pair of clamp arms 2 which are hingedly connected together at one end 3, and are capable of either moving apart or coming together to exert a gripping action at the other end 4 as shown in FIG. 1, for instance. Rubber or other suitable elastomer inserts 5 (see FIG. 12) improve the grip of the arms 2 when used to exert a gripping action. The externally threaded spindle 6 (see FIG. 13) acts as a support means for the clamp device, and is actuated by a knurled head 7 (see FIG. 2) in such manner that, when the head 7 is rotated in one direction, the clamp device, the gripping ends 4 of the actuated clamp moving apart from one another, and when the head 7 is rotated in the opposite direction, the gripping ends 4 come together to exert a desired gripping action. Brass studs (not shown) are inserted into the screw drive of the actuating heads.

A locking mechanism 11 is mounted on the threaded spindle 6 to act as a support means for a pair of clamps 1 to allow the two clamps to act together when the mechanism 11 is in its locked state, but to allow independent action of the two clamps when the locking mechanism 11 is in its unlocked state. In one simple form (as shown), the locking mechanism 11 comprises a pair of clutch members with interlocking teeth which, when engaged in the closed position of the locking mechanism 11, prevent either clamp 1 from rotating on the spindle independently of the other, the two clutch members being disengaged from one another simply by pulling them sufficiently apart, in precisely the same way as a conventional clutch may operate in a conventional automotive vehicle.

FIGS. 1-4 show knurled heads 7 (see also FIG. 8-10) at opposite ends of the threaded spindle 6 of FIG. 13, which constitutes the support means. The heads 7 constitute actuating mechanisms for the clamps 1. The heads 7 are mounted on the threaded ends of the spindle 6, and are designed so that the rotation of a head in one direction is transmitted to the adjacent clamp 1, and causes, for example, closing of the clamp, whilst rotation in the opposite direction acts upon the clamp 1 to open the clamp. Studs 8 are provided on the inside faces of the gripping ends 4 for receiving corresponding recesses 8 in the rubber or like elastomer inserts 5 (see FIGS. 5 and 12).

FIGS. 9 and 10 show an ordinary dual functioning clamp device similar, in many respects, to the universal clamp device illustrated in FIGS. 1-8, but with the essential difference that the clamp device of FIGS. 9 and 10 comprises a single clamp 1 only, whose clamp arms 2 are shown in their closed position. The device of FIGS. 9 and 10 is, therefore, not an universal clamp device.

Thus, with reference to the invention embodied in our GB Patent 2366254 and our International application PCT/GB01/05595, the clamp device of FIGS. 9 and 10 corresponds to the clamp (3) described and illustrated in the latter patent and application, respectively, whereas the universal clamp device illustrated in FIGS. 1-8 of our co-pending GB Patent Application 0305659.5, filed on 12 Mar. 2003) corresponds to the clamp (6) shown and described in the said GB Patent 2366254 and International Application PCT/GB01/05595.

As can be seen from FIGS. 9 and 10, the illustrated device may comprise a plurality of pierced disc or plate members 13 mounted on the supporting spindle 6 of the device, to which the ribs of the raincover, which is the subject of the above-noted GB Patent and International Application, are attached. It will be appreciated, however, that the latter is only a preferred application of the single clamp device of FIGS. 9 and 10, which is clearly of wider application. In the device of FIGS. 9 and 10, the plates/discs 13 can be rotated to different positions (check canopy rib slots) thus allowing the entire canopy to be in its open/extended position. As can be seen from FIG. 10, with all plates/discs 13 in line, the entire canopy will be in its closed/folded state. The rotating plates 13 are such that the canopy ribs are able to clip into purpose made slots in the plates 13.

FIG. 12 shows two views of one of the rubber or elastomer inserts 5 provided with recesses 8 for receiving the studs on the inside faces of the gripping ends 4 of the clamp arms 2. FIG. 11 is an end view from the outside of a knurled head 7 and FIG. 13 shows the spindle 6 which is threaded at both ends.

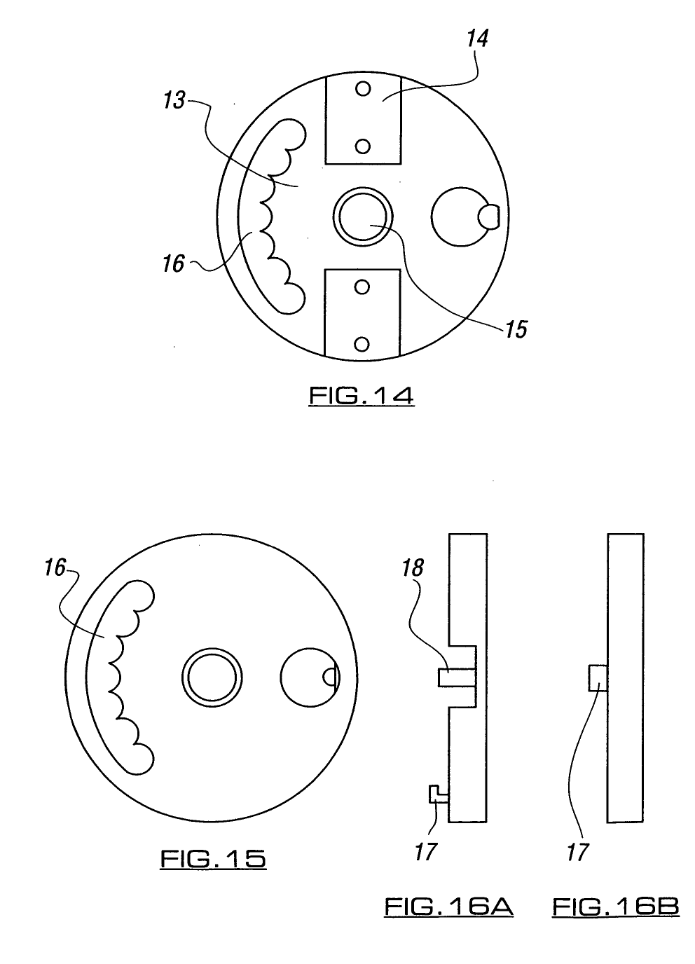

FIGS. 14-16 are views of the plates/discs (four per clamp), which attach the canopy ribs (not shown) to the dual functioning clamp devices of the invention.

FIG. 14 is an inner side view of the plate/disc 13 and FIG. 15 and outer side view.

FIGS. 16A and 16B are side views of a disc/plate 13.

The disc/plate shown in FIGS. 14 and 15 is provided with purpose-built slots 14 (see FIG. 14) into which the canopy ribs (not shown) are clipped. A centre aperture 15 in the disc/plate 13 receives the spindle 6. Hook-positioning bays 16 receive hooks 17 on the disc/plates 13 (see FIGS. 16A and 16B). Each canopy rib (not shown) fits on at 18 as shown in FIG. 16A. As regards the bays 16 shown in FIGS. 14 and 15, individual plates are connected to each other at a bay 16, the dimensions of which allow the disc/plates 13 to rotate independently when the entire canopy is to be opened and closed.

1 A clamp device comprising at least one clamp mounted on a support means and capable of rotation thereon, the clamp being constituted by a pair of clamping arms hingedly connected at one end to allow pivoting of said arms between open and closed positions and each arm being shaped and/or adapted at its other end to exert clamping pressure in the closed position of the clamp, and an actuating mechanism being provided on the said support means which, on rotation thereof, is capable in one direction of rotation of opening the clamp by causing the clamping arms to move away from one another at said other end thereof, and in the opposite direction of rotation of closing the clamp by causing said other end to approach one another and to exert clamping pressure.

2 An universal clamp device according to claim 1 comprising a pair of clamps mounted on a support means and capable of independent rotation thereon, each clamp being constituted by a pair of clamping arms hingedly connected at one end to allow pivoting of said arms between open and closed positions in the use of the clamp, and each clamping arm being shaped and/adapted to exert clamping pressure at its other end in the closed position of the clamp, a locking mechanism being provided on said support means which, in its locking state, links said clamps together to prevent movement thereof as a whole independently of one another, and in its unlocked state allows each clamp to move independently of the other on the support means, separate actuating means being provided for the clamps to allow opening and closing of each clamp independently of the other.

3 A clamp device according to claim 1 comprising one clamp only as defined in claim 1 and optionally provided, mounted on the support means, with a plurality of disc members which are pierced to provide means for attachment of the ribs of a raincover as described and claimed in GB patent no. 2366254.
